(19) United States
(12) Patent Application Publication
(10) Pub. No.: US 2017/0038145 A1
(43) Pub. Date: Feb. 9, 2017

(54) HIGH TEMPERATURE ALLOY PARTICLE DOSING DEVICE

(71) Applicant: Rassini Frenos, S.A. de C.V., San Martin Texmelucan (MX)

(72) Inventors: Carlos González Rivera, Ciudad de México (MX); Marco Aurelio Ramírez Argáez, Ciudad de México (MX)

(21) Appl. No.: 15/228,731

(22) Filed: Aug. 4, 2016

(30) Foreign Application Priority Data
Aug. 7, 2015 (MX) MX/A/2015/010258

(51) Int. Cl. F27D 3/18; C22B 9/10; F27D 21/00; C21C 7/00; F27D 13/00

(52) U.S. Cl. CPC F27D 3/18; C21C 7/0006; C21C 7/0025; C21C 7/0043; C21C 7/0068; F27D 13/00; F27D 21/0014; C22B 9/10; F27M 2001/015; F27M 2001/01; F27M 2001/02; F27M 2001/04

(57) ABSTRACT

A process and a device are provided that avoid the problems expressed earlier in order to produce a current of alloy particles at temperatures above 400° C. that will ultimately be used to alloy or chemically treat liquid metal streams. The invention that is presented is composed of a chamber heated by one or more gas burners, where a current of alloy particles with the pre-established massic or volumetric flow is input either manually or via the use of a gravimetric or volumetric dosing device that operates at room temperature located in an area above the chamber. These particles are heated by radiation from the walls of the chamber and by the radiation and convection of the flames of the burners that sweep them along during their flight inside the device for the time that they remain inside the chamber. As result of the use of the proposed device and the process, during which a great amount of energy is received during their passage through the device, the alloy particles reach the required temperature prior to their incorporation into a metallic current.

### TECHNICAL FIELD

This invention corresponds to the metallurgical domain, specifically the field of the melting of ferrous and non-ferrous alloys, steel melting, and metallurgical processes that involve the addition of pulverized alloy elements heated to temperatures above 400° C. to be used for incorporation in liquid metal streams, with the aim of adjusting its chemical composition or undertaking some treatment of the liquid metal.

### BACKGROUND

Currently there are no volumetric or gravimetric dosing devices on the market that provide controlled massic or volumetric flows of particles at temperatures above 400° C., since at these temperatures, particles tend to congregate and sinter. Additionally, the conditions for heat corrosion and thermal fatigue in the components of dosing devices require the use of special materials for their manufacturing such that they resist these conditions. Nevertheless, and in spite of the use of sophisticated materials such as superalloys in the manufacturing of the components of dosing devices that operate at high temperatures, the aforementioned adverse conditions shorten their service lives, making them unviable for commercialization.

Different state-of-the-art strategies have been used to resolve these problems, such as heating a flow of particles whose output has already been controlled by volumetric or gravimetric dosing device, which then falls into a reaction chamber. Said current of particles can be heated by different means, such as for example by using overheated gases in a plasma state, or a high-powered laser energy source. A gas vector can also be used to direct the current of particles towards a fluidized bed reactor where the particles are heated. In the inventors' opinion, all these solutions are complex and costly. In the state of the art, patents U.S. Pat. No. 6,994,894, EP 788,987, U.S. Pat. No. 5,738,249, US 2012/027441, and U.S. Pat. No. 7,252,120 describe examples of devices and procedures for heating particles after a dosing device, before a dosing device, and conventional dosing devices for particles at room temperature. The text of said documents is incorporated into this document as background.

As a consequence, with this invention a process and device are provided with which the problems expressed above are avoided. The invention presented below is composed of a heated chamber with one or more gas burners, where a current of particles is received that is added manually or via a massic or volumetric flow controlled by a gravimetric or volumetric dosing device that operates at room temperature and is located somewhere above the chamber. These particles are heated by radiation from the walls of the chamber and the flames of the burners or by convection via the hot gases of combustion during their flight when inside the chamber, reaching the required temperature.

### BRIEF DESCRIPTION OF THE DRAWINGS

FIG. 1.—Schematic Representation of the chamber for heating alloy particles. (a) Top View; (b) Crosscut View.

FIG. 2.—System for preheating particles used during experimentation.

FIGS. 3a.-3c.—Photographs and diagram showing the implementation used during the experimentation. FIG. 3a.—Photograph showing the implementation of the chamber from the outside of the device; FIG. 3b.—Diagram showing the positions and identifying the thermocouples in the chamber and in the receptacle receiving the particles; FIG. 3c.—Photograph from outside the device showing the implementation of the receptacle that receives the particles with type K thermocouples connected to a data logging system.

FIG. 4.—Photograph of the system during heating tests performed on the chamber.

FIGS. 5a and 5b.—Evolution of the temperatures measured in the interior of the chamber during the initial heating tests of the chamber with two different process conditions. FIG. 5a.—Use of a burner and natural gas; FIG. 5b.—Use of two burners and a mix of natural gas and compressed air.

FIGS. 6a and 6b.—Photographs showing the development of the manual introduction of a known mass of particles into the heating chamber. FIG. 6a.—Placement of the tube for introducing the particles; FIG. 6b.—Addition of alloy particles.

FIGS. 7a and 7b.—Temperature measurements of copper particles in the receiving receptacle at the exit of the dosing device under two initial temperature conditions for the receiving receptacle. FIG. 7a.—Initial temperature of the receiving receptacle of almost 200° C.; FIG. 7b.—Initial temperature of the receiving receptacle of approximately 100° C.

FIG. 8.—Temperature measurements of 75% ferrosilicon in the receiving receptacle at the exit of the dosing device.

### DESCRIPTION OF THE INVENTION

The process and device that constitute the invention avoid the problems stated earlier. The device is composed of a heated chamber with one or more gas burners, where a current of particles is received that is manually added or added via a pre-established massic or volumetric flow from a gravimetric or volumetric dosing device that operates at room temperature and is located somewhere above the chamber. These particles are heated by the radiation of the walls of the chamber and the flames of the burners and also by convection from the hot gases from combustion during their flight while they are inside the chamber, such that by controlling the residence time in the chamber, when they have finished passing through the chamber they have reached the required temperature.

The device permits heating a current of solid alloy particles, controlled with respect to their volumetric or massic flow and particle size, which fall by gravity into a region adjacent to the wall of the chamber, which is made of refractory material or another material that is resistant to high temperatures that is heated with burners, such that the heating of the particles is performed via the transfer of heat by radiation from the walls of the chamber and by convection and radiation from the flame towards the particles during their residence time in the chamber, in a reducing or oxidizing atmosphere, which constitutes the essential principle of the process.

The device is composed of a cylindrical chamber with a truncated cone-shaped end made out of refractory material or another material that is resistant to high temperatures, where there are one or more burners directed tangentially at the wall and pointed downward, with their flames at a predetermined angle between 0° and 45° from horizontal, such that depending on the angle and the volumetric input and nature of the combustion gases that enter via the burners, the particles reach a certain temperature as they leave the device. The angle used and the gaseous volumetric flow introduced establish the trajectory and the residence time of the flames of the burners and the particles that are swept along by these flames into the preheating chamber. A low angle and the use of low volumetric flows of gases introduced into the burners causes a greater residence time for the flames and particles in the chamber. The use of greater volumetric flows of gases used in the flame brings greater thermal energy into the chamber, but it reduces the residence time of the particles. The reducing or oxidizing nature of the gases used to operate the system depends on the mix of combustible gas such as natural gas, LP gas, or any other type of combustible gas that is combined with oxygen, whether from a pressurized air current or air that is enriched with oxygen, and the proportions used determine the calorific value that the flames obtain, which in turn establishes the maximum temperature that the flames reach, the maximum temperature to which the particle preheating chamber can be heated, and the temperature that the particles reach upon leaving the system. The adequate balance of the currents used of air containing oxygen or oxygen and combustible gas, which can be achieved by any expert in burners, allows for obtaining an appropriate mix with the greatest calorific power and a reducing or oxidizing nature as required.

Most of the combustion gases rise in the central region of the chamber towards the upper part of the area, where they are evacuated out of the chamber. Once the internal surface of the chamber has reached an adequate temperature, above 950° C. as measured via thermal sensors, the temperature at which it has been experimentally confirmed that it emits an amount of radiation sufficient to heat the alloy particles of the type and size of interest for this application to temperatures above 400° C. as required, a controlled massic or volumetric flow of alloy particles with a pre-established particle size with average diameter of between 0.1 mm and 8 mm, and especially particles with an average diameter between 0.3 and 3 mm, is introduced in a region adjacent to its vertical walls coining from manual feeding or from a gravimetric or volumetric dosing device, such that during the time it spends within the chamber, these particles are heated by the radiation coining from the walls of the chamber and the flames of the gas burners, and also by convection mechanism of the hot combustion gases in contact with the particles while they are swept along by the combustion gases following a circular descending trajectory, sticking closely to the walls of the chamber, until upon their arrival at the bottom the particles continue their descending trajectory while the combustion gases are directed along the symmetry axis of the cylindrical chamber and up, leaving the device.

The device was tested at the Industrial Plant in order to corroborate the functioning of the particle dosing device system at high temperature, for which the device was constructed using a metallic support structure, a metal shell to support its components, and a moldable refractory material to work at high temperatures.

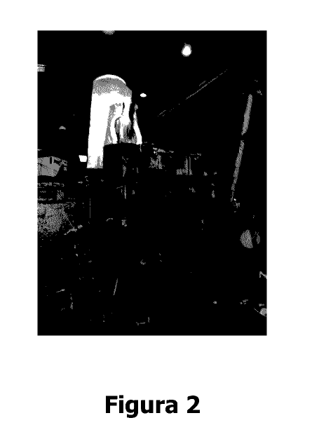

Said device is shown in FIG. 2. The heating chamber was implemented with six type K thermocouples in two sets of three, at different heights within the chamber, with each thermocouple forming a 120° angle with the two other ones. At the exit of the particle dosing device a cylindrical receiving receptacle was placed, implemented with four thermocouples at different heights. The preheated particles were received in this receptacle. The thermocouples were connected to the Daqview p86 data logging system by Data Translation.

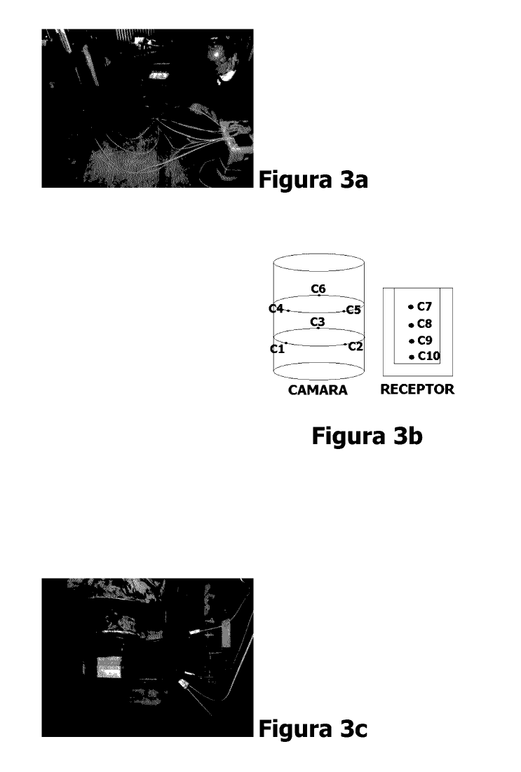

In order to heat the chamber, two gas burners were used, with the mouths where the flames come out located tangentially with respect to the wall of the chamber and directed downward forming a 15° angle from horizontal and fed with natural gas and compressed air. The implementation of the system can be seen in FIG. 3.

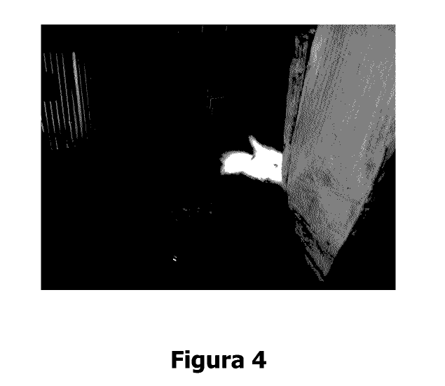

Preliminary measurements were made of the heating of the chamber using different angles and combustion mixes, as illustrated in FIG. 4, with the speed of heating and maximum temperature that is reached inside the chamber depending on the number of burners, the volumetric flow, and the nature of the combustion gases used, and the angle of inclination of the flames.

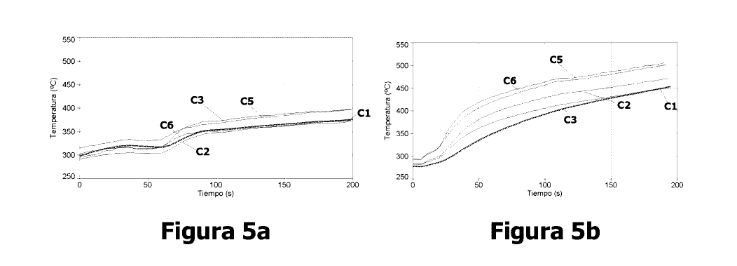

In FIG. 5 two measurements of the heating of the chamber are shown under different process conditions. Clear differences can be noted between the two heating kinetics, which indicates that the heating system used, which involves a structure that allows for placing the mouths of the burners tangentially to the wall of the chamber and at different angles with respect to horizontal, is a versatile heating system and that optimum heating conditions can be reached via the adequate adjustment of the aforementioned variables. In graph (a) of FIG. 5, results are shown for the use of a single burner that introduces a current of natural gas, while the results shown in graph (b) of this figure correspond to the use of two burners and a mix of natural gas and compressed air. It can be corroborated that the use of two burners along with the introduction of oxygen contained in the air current notably improves the speed with which the chamber is heated.

The alloy particles of interest for this invention include high density alloy particles such as particles of copper, nickel, ferrochrome, ferromolybdenum, ferrovanadium, and all particles that are alloys or used for treating liquid metal with apparent densities greater than 5 gr/cm³, as well as low-density alloy particles such as particles of graphite, ferrosilicon, and all particles that are alloys or used for treating liquid metal with apparent densities less than 5 gr/cm³.

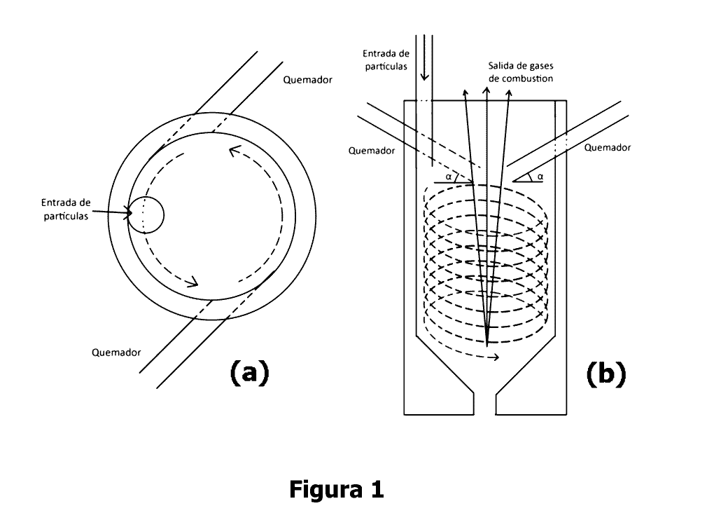

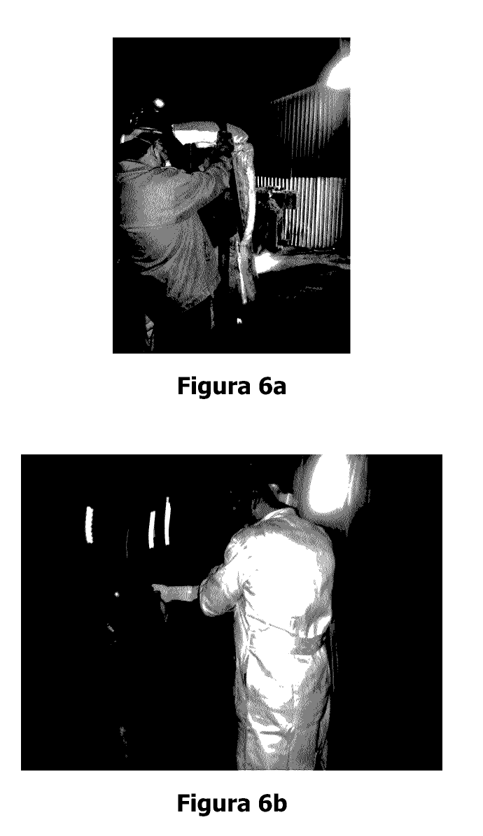

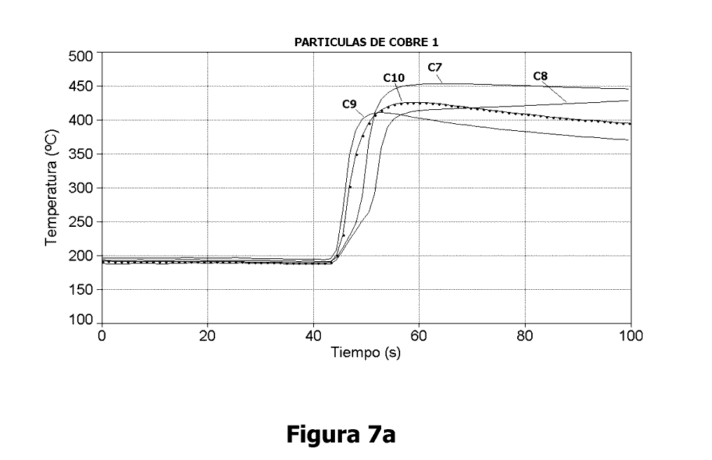

With the aim of verifying the effectiveness of the device that is the object of this invention with high and low density alloy particles, heating tests were carried out with copper particles (apparent density of 8.9 gr/cm³) and with particles of 75% ferrosilicon, Fe-75% Si (apparent density of 3.7 gr/cm³). A pre-established amount of 600 grains of the particles was weighed out in the case of copper and 300 grams in the case of Fe-75% Si, which were added at room temperature via a steel duct equipped with a funnel on top, in an area next to the wall of the chamber, as illustrated in FIG. 6 and indicated diagrammatically in FIG. 1.

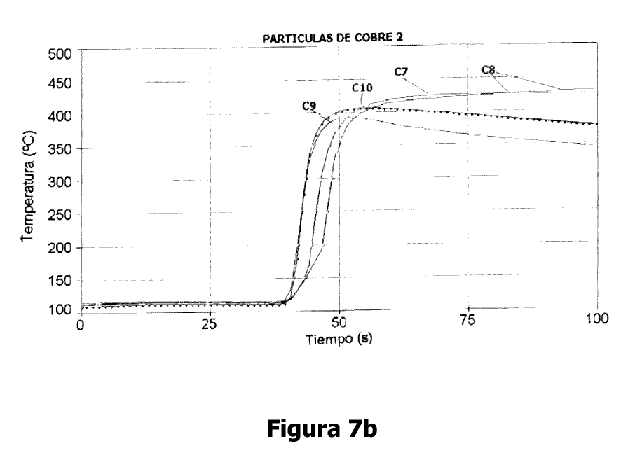

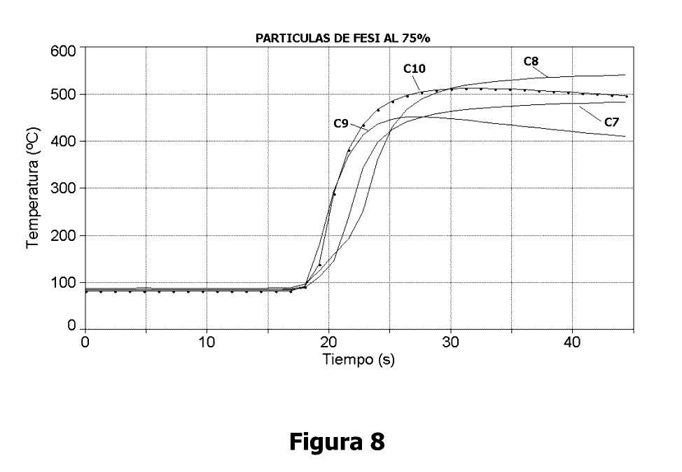

Upon analyzing FIG. 7(b), which shows the evolution of the temperature inside the mold receiving the particles, it is observed that before the particles arrive, the receiving receptacle was at a temperature close to 100° C. and that Channel 7 recorded maximum temperatures of around 420° C. With respect to the heating of the particles, FIGS. 7(a) and 7(b) are typical results associated with the heating of copper alloy particles and show the thermal histories within the receptacle. In both cases it starts with a warm receptacle, at 200° C. in the first experiment and 100° C. in the second, and at the time of feeding the particles and until the end of the feeding, 15 seconds in both cases, the temperature is increased up to obtaining maximums of 450° C. (experiment 1) and 420° C. (experiment 2). These temperature increases are associated only with the heating of the particles during their fall and passage through the device and are independent of the initial temperature of the receptacle, since before the particles enter, the thermocouples are in the center in contact with the atmosphere, while as they enter, the particles come in contact with the thermocouples. In other words, if the particles entered the pre-heating system at room temperature (30° C.), the net increase was 420° C. and 390° C., which are the results of the net sensible heats obtained with this device.

FIG. 8 shows the results obtained for particles of 75% ferrosilicon, where it can be verified, in this last case, that the particles reach temperatures above 500° C. in spite of the fact that the receptacle was originally at less than 100° C.

The results obtained suggest that according to the process conditions and the nature of the particles, it is possible to reach temperatures above 400° C. for alloy particles heated via the proposed device, which is something that is unprecedented to date.

Finally, it is important to emphasize that experiments were also performed reaching the same initial temperature in the walls of the chamber, but turning off the burners during the addition of the particles, in which case, the particles only heated up at the beginning, which suggests that the fluid dynamics of the combustion gases that sweep the particles along during their flight inside the chamber and the process variables that determine said dynamics are responsible for the temperatures achieved by the alloy particles as they leave the device at its exit.

1-11. (canceled)

12. A high temperature alloy particle dosing device comprising:
a cylindrical chamber including a truncated cone-shaped end, the cylindrical chamber formed of a refractory material or another material resistant to high temperatures;
at least one burner aimed tangentially at a wall of the cylindrical chamber and downward;
a particle dosing device;
a plurality of thermal sensors; and
a metallic structure, a metallic shell that supports the other components and moldable refractory material or other material appropriate for operating at high temperatures.

13. The device of claim 12, wherein the at least one burner is directed downward at an angle between 0° and 45° from horizontal.

14. The device of claim 12, wherein the volumetric flow and composition of the combustion gases entering the cylindrical chamber through the at least one burner determines the temperature that the particles reach upon exiting the device. (New) The device of claim 12, wherein the angle of the at least one burner and the volumetric flow determine the trajectory and the residence time of the flames of the at least one burner and the particles that are swept along by these flames inside the heating chamber.

16. The device of claim 12, wherein the at least one burner uses a reducing mix of combustion gases.

17. The device of claim 12, wherein the at least one burner uses an oxidizing mix of combustion gases.

18. The device of claim 12, wherein the at least one burner uses a mix of combustion gases comprising natural gas, LP gas, or any other type of combustible gas, which is combined with oxygen contained in a pressurized air current or a pressurized air current enriched with oxygen, the proportions used and chemical characteristics of the gaseous flows used determining the calorific power of the flames obtained.

19. The device of claim 12, wherein the thermal sensors are one of thermocouples connected to a data logging system and a system permitting instantaneous measurement of the temperatures present at one or more points within or at the entrance or exit of the chamber of the dosing device during its operation.

20. The device of claim 12, wherein the size of the particles is of an average diameter of between 0.1 mm and 8 mm.

21. The device of claim 20, wherein the size of the particles is of an average diameter of between 0.3 mm and 3 mm.

22. The device of claim 12, wherein the alloy particles include high density alloy particles comprising copper, nickel, ferrochrome, ferromolybdenum, or ferrovanadium particles, and all particles that are alloys or that are used for treating liquid metal with apparent densities greater than 5 gr/cm³ and mixes of them, as well as low-density alloy particles such as graphite or ferrosilicon particles, and all particles that are alloys or that are used for treating liquid metal with apparent densities less than 5 gr/cm³ and mixes of them.

23. A process for the addition of pulverized alloy elements at temperatures greater than 400° C. that can be added to liquid metal streams for the purposes of adjusting its chemical composition or undertaking some treatment of the liquid metal, the process comprising:
placing in the heating chamber one or more thermal sensors, the thermal sensor comprising at least one of thermocouples connected to a data logging system and any system that permits the instantaneous measurement of the temperatures present at one or more points inside or at the exit or entrance of the chamber of the dosing device during its operation, with the purpose of verifying that the chamber has reached an adequate temperature for heating the alloy particles prior to their entry into the chamber;
placing a receiving receptacle at the exit of the dosing device in order to collect the hot particles, or also when liquid metal is introduced into the chamber, a pan for collecting the alloyed or chemically treated liquid;
heating the chamber using gas burners with the mouths where the flames come out located tangentially to the wall of the chamber and directed downward forming an angle between 0° and 45° from horizontal and fed with a mix of combustion gases comprising natural gas, LP gas, or any other type of combustible gas, which is combined with oxygen contained in a pressurized air current or a pressurized air current enriched with oxygen;
weighing the pre-established amount or total mass of alloy particles desired to be added if the particles are added manually;
adjusting the device to provide the mass flow required for alloy particles during the time that the addition of particles lasts to introduce the total mass of alloy particles required if the particles are added in an automated manner using a particle dosing device, whether volumetric or gravimetric;
activating the entry of the flow of liquid metal required to be alloyed or chemically treated once the thermal sensor(s) indicate that the chamber has reached the temperature required to heat the particles up to the desired temperature;
adding the amount of previously weighed alloy particles in the chamber for the required amount of time, using a steel duct equipped with a funnel at the top or any other device that serves to direct the current of alloy particles introduced towards an area next to the wall of the chamber, so that the particles are incorporated into the metallic current being treated as it passes through the chamber if the addition of particles is performed manually; and
activating the particle dosing device so that the current of particles is introduced into the heating chamber, using a steel duct equipped with a funnel at the top or any other device that serves to direct the mass flow of alloy particles towards an area next to the wall of the chamber for the required amount of time, thus ensuring that the total mass of alloy particles introduced is eventually incorporated into the metallic current being treated as it passes through the chamber if the particles are added in an automated manner using a particle dosing device, whether volumetric or gravimetric.
